(19) United States
(12) Patent Application Publication
(10) Pub. No.: US 2023/0259120 A1
(43) Pub. Date: Aug. 17, 2023

(54) INTELLIGENT WORKFLOW ENGINE FOR MANUFACTURING PROCESS

(71) Applicant: Honeywell International Inc., Charlotte, NC (US)

(72) Inventor: Niranjan Amrutur Subba Rao, Bangalore (IN)

(21) Appl. No.: 18/001,577

(22) PCT Filed: Jul. 16, 2021
(86) PCT No.: PCT/US2021/042062

§ 371 Date: Dec. 12, 2022

Related U.S. Application Data
(60) Provisional application No. 63/053,345, filed on Jul. 17, 2020.

(51) Int. Cl. G05B 23/02

(52) U.S. Cl. CPC G05B 23/0297; G05B 23/024; G05B 2223/06

(57) ABSTRACT

A system and method include receiving time series values of one or more sensed parameters of a product manufacturing processes. The received time series values are compared to desired time series values to detect one or more anomalies in the received time series values. An action to apply to the product manufacturing process product is determined based on the one or more detected anomalies is orchestrated by an intelligent workflow engine, that derives inferences from analytics, heuristics rules, skills, and a knowledge library.

### BACKGROUND

Manufacturing of any product can be a complex process that requires extensive coordination between various steps, equipment, process, people, units, and entities, both within the same organization and outside the organization. Such manufacturing includes customer management, raw material management, cost optimization, material availability, order processing \ management, planning, scheduling, tracking, executing the work order, warehousing, and shipping etc. Each of these operations typically is responsible for portions of the manufacturing process or flow which includes sub operations.

Each of the operations may also be subject to errors which can adversely affect both product quality and manufacturing throughput. When an error is discovered at any point in the manufacturing process, it can be difficult to determine how to handle products that are being processed, especially during batch manufacturing processes.

### SUMMARY

A system and method include receiving time series values of one or more sensed parameters of a product manufacturing processes. The received time series values are compared to desired time series values to detect one or more anomalies in the received time series values. An action to apply to the product manufacturing process product is determined based on the one or more detected anomalies.

### BRIEF DESCRIPTION OF THE DRAWINGS

FIG. 1 is a block flow diagram of a workflow system for detecting anomalies and providing an action for a manufacturing process according to an example embodiment.

FIG. 2 is a block diagram of a packaging operation product batch workflow according to an example embodiment.

FIG. 3 is a flowchart illustrating a computer implemented method for recommending actions in response to a manufacturing processing deviating from an ideal set of measured parameters according to an example embodiment.

FIG. 4 is a flowchart illustrating a computer implemented method of tracking produced products and corresponding time series data recorded during product manufacturing according to an example embodiment.

FIG. 5 is a flowchart illustrating a computer implemented method of an alternative way of determining an action to be performed with respect to manufacture of a product that has deviated from ideal parameters values according to an example embodiment.

FIG. 6 is a block diagram of an example of an environment including a system for neural network training according to an example embodiment.

FIG. 7 is a block schematic diagram of a computer system to implement one or more example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software in one embodiment. The software may consist of computer executable instructions stored on computer readable media or computer readable storage device such as one or more non-transitory memories or other type of hardware based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine.

The functionality can be configured to perform an operation using, for instance, software, hardware, firmware, or the like. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware. The term, “logic” encompasses any functionality for performing a task. For instance, each operation illustrated in the flowcharts corresponds to logic for performing that operation. An operation can be performed using, software, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system.

Furthermore, the claimed subject matter may be implemented as a method, apparatus, or article of manufacture using standard programming and engineering techniques to produce software, firmware, hardware, or any combination thereof to control a computing device to implement the disclosed subject matter. The term, “article of manufacture,” as used herein is intended to encompass a computer program accessible from any computer-readable storage device or media. Computer-readable storage media can include, but are not limited to, magnetic storage devices, e.g., hard disk, floppy disk, magnetic strips, optical disk, compact disk (CD), digital versatile disk (DVD), smart cards, flash memory devices, among others. In contrast, computer-readable media, i.e., not storage media, may additionally include communication media such as transmission media for wireless signals and the like.

Manufacturing of any product can be a complex process that requires extensive coordination between various steps, equipment, process, people, units, and entities, both within the same organization and outside the organization. Such manufacturing includes customer management, raw material management, cost optimization, material availability, order processing \ management, planning, scheduling, tracking, executing the work order, warehousing, and shipping etc. Each of these operations typically is responsible for portions of the manufacturing process or flow which includes sub operations.

Processes of manufacturing process may be substantially automated. However, the communication and integration among the various process flows may be lacking. Often this lack of integration is a result of the various process that are responsible for the many different aspects of the overall manufacturing process. Completing the entire manufacturing process often requires extensive interaction between each of processes, equipment, employees.

It is difficult to understand what problems may be occurring, contextualize the problems, analyzing problems within a short time frame to avoid impacts to throughput, finding alternate solutions, and identifying and implementing a best solution to result in minimal productivity and disruption impacts.

There are multiple interactions that may give rise to deviations in a batch process, including human to machine interactions, machine to machine interactions, machine to process interactions, process to process interactions, and process to human interactions.

Inconsistent communication of application workflow status at top level workflow controls leads to issues at the equipment level, lack of data driven and reality-based decision making and missed production deadlines. It is also difficult to know where operators move the product when it is rejected, which workflow was used with excess inventory at a station, and inventories kept by the product manufacturer as such excess inventory has low visibility.

In various embodiments, a workflow system provides smart manufacturing with enhanced capabilities combine information/communication technologies through workflow with existing manufacturing systems. Data analytics driven workflow provides for better decision making. Entity (Machine, Process, human) to Entity (Machine, Process, human) communication is provided through a hierarchical data driven workflow method.

The workflow system determines an action to take with respect to product being manufactured during batch processing. The system receives time series values of sensed parameters during batch processing of the product, aggregates the values, provides a context for the values, and compares the aggregated values with context to nominal ideal or golden batch values at the same process times to detect anomalies.

An analytics engine is used to recommend an action on how to proceed with the batch process or product based on the detected anomalies. Various methods may be used to correlate detected anomalies to determine the action. In some embodiments, the analytics engine determines one or more actions based on knowledge of past patterns and actions such as by using a trained machine learning model. The actions may also be determined based on rules corresponding to standard operating procedures or even based on operator skill. Actions may even be determined for batch-like portions of a continuous process.

The workflow system operates dynamically during the batch process enabling interruption of the batch process, revising control parameters for the batch process, revising the manufacturing process for partially processed materials, or even designating intermediate product or final product for rework or scrapping.

Golden batch parameter values may be updated based on the quality of a batch process that resulted in better quality product.

In some embodiments, data corresponding to the sensed parameters and actions applied to a batch may be stored for use in part callback tracking to accurately identify parts to call back by comparing data for parts later found to be deficient to various prior batches of parts. In further embodiments, the analytics engine can be used for evacuation strategies by comparing a number of people in a building, evacuation paths, and even adjusting the number of open doors based on detected anomalies during evacuations from prior evacuations with similar parameters that worked well.

One use case example utilizes a packaging unit. The workflow system can be generalized to work for several use cases, outside of industrial batch processing. A learning system of the workflow system is created by aggregating data from underlying systems, that compiles into a Rules. Skills, and Knowledge library. The learning system is used by the analytics engine to recommend actions as a function of current manufacturing measured parameters.

In response to an event occurring, the workflow system queries the analytics engine to determine a “workflow” that should be initiated. The Analytics engine can also suggest a “new workflow” based on the best path an event should be directed to.

In one example batch manufacturing scenario, a reactor in a chemical plant has experienced temperature variations during the execution of a Batch. The supervisor/operator is in a dilemma to know if the batch has gone off specification. It can be difficult to determine the correct action regarding how to handle the batch. Example actions might include sending the sample to a laboratory for analysis, accept the batch as-is and mark it as “standard” quality, reject the batch, reuse the batch output as an input in the same reactor and adjust recipe for reused material, reprocess the batch output and separate out chemicals to be used elsewhere, repurpose the batch output to be used for a different usage, or even downgrade batch output as lower quality or a different product and sell at a lower price.

In one embodiment, the analytics engine is used to analyze exceptions. Exceptions may be generated in response to measured parameters exceeding a threshold difference from parameters of previously known good batches, such as a best batch’s parameters. The best batch may be referred to as a golden batch. Exception based actionable mobile workflow is used to effectively manage process deviations with visual analytics available for operators. Since exceptions may be generated at any time during processing, dynamic intelligent workflow management is provided by analytically determining the state of the workflow and providing recommended next steps in the event of a deviation.

The measured parameters may also be used for predictive analytics to identify when a batch is going to go bad before it happens and to take corrective action. The analytics engine may also aid in scheduling by comparing batch data against plans and schedules to ensure manufacturing materials are available when needed. Optimum operating parameters may also be found based on analysis of prior batch data and can be balanced against batch processing times to improve cycle time and monitor equipment effectiveness.

By tracking batch quality and corresponding process parameters, quality may be better tracked and managed. Such tracking across batches may include genealogy tracking for better managing potential recalls of product. If a batch is found to be defective after shipping, products from that batch are easily identified. Other batches with similar parameters may also be identified and investigated for potential recall, allowing more selective and effective recalls, providing end-to-end traceability.

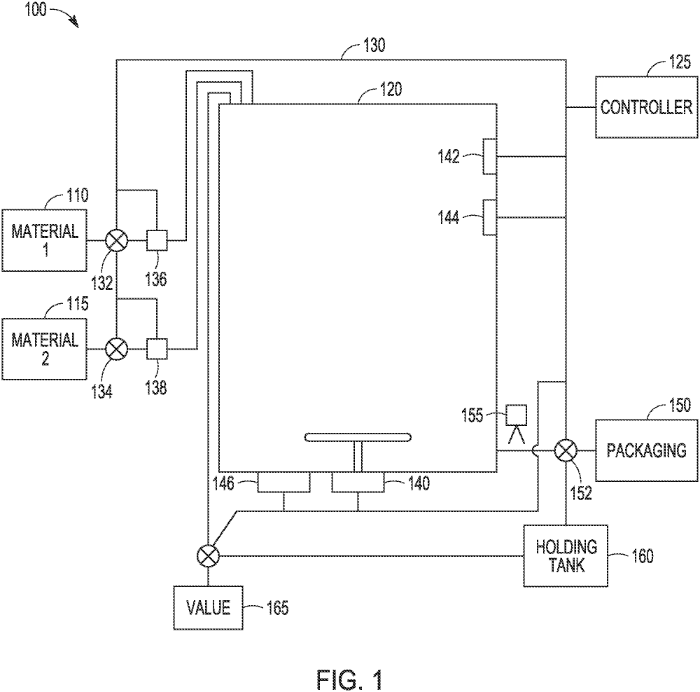

FIG. 1 is a block flow diagram illustrating a simple batch manufacturing process 100. Process 100 receives two materials, material 1 at 110 and material 2 at 115. The materials are to mixed and heated in a container 120. A controller 125 is programmed to control the batch process. The controller 125 is coupled via control lines 130 to multiple actuatable valves, such as valves 132 and 134 to control the amounts of each material provided to container 120. Controller 120 may be a conventional process control system that includes many different control functions such as proportion/integral/derivative (PID) control functions. In addition, controller 120 may also include inferencing and analytics engines as described in further detail below.

Flowrate sensors 136 and 138 may also be coupled to sense flow rates of each material and provide flow rate parameter values to controller 125 via control lines 130. Note that control lines 130 may be individual wires, such as 2 wire conductors, for each sensor or actuator, a shared bus, or is representative of wireless connections.

Once the materials are provided to the container 120, a stirring mechanism indicated at 140 is used to mix the contents for a desired period of time. The stirring mechanism is also coupled to the controller 125 to receive control signals for controlling the speed and period of time for the stirring to occur. Temperature and pressure within the container 120 are measured via respective sensors 142 and 144. The sensors provide temperature and pressure parameter values to the controller 125. Some reactions of the materials in the container 120 may be exothermic or endothermic. Reaction rates and sufficiency of mixing may be a function of temperature and stirring. A heater 146 may be thermally coupled to the container 120 to heat the container and contents under control of controller 125. Additional sensors may be used to sense a level of materials within the container 120 or other parameters as desired.

In response to the materials being suitably mixed, a resulting product may be ready for packaging indicated at 150. A valve 152 coupled between container 120 and packaging 150 is controlled via controller 120 to move the product to packaging 150. A sensor 155 positioned between the valve 152 and container 120 may be used to determine the quality of the product. A simple optical sensor 155 may be used in one embodiment to determine the clarity or color of the product. Many different types of sensors may be used in different embodiments to determine quality of the product.

All the sensor values are stored by the controller as time series data and are utilized to determine actions at various times in the batch process 100. As described in more detail below, deviations from time series data from a prior ideal or golden batch may cause an exception to the process to occur at any time during the process. In one example, if the temperature of the container during mixing deviates a threshold amount from the ideal batch parameters, actions associated with successful prior batch processes that resulted in a good product may be identiifed and applied to the process. In one example, if the temperature deviates on the low side of ideal, a speed of the stirring mechanism 140 may be increased. In another example, if the temperature deviated further on the low side, a similar prior batch may indicate that both the speed of the stirring mechanism needed to be increased as well as having additional heat provided by heater 146.

Many such actions may be identified based on exceptions during the processing of a single batch. In one example, following completion of mixing in container 120, the product is tested for quality at senstor 155. If the quality is inadequate, valve 152 may be used to divert the product into a holding tank 160 depending on similarity to prior product time series sensor readings. Many different actions can be taken at this point based on such similar prior product actions, such as controlling a valve 165 to route the product back to container 120 for further processing that worked for the simlar prior batch, or sending the product for lab testing as indicated at 170, or even discarding the product as waste. Another outcome may be to package the product at 150 with a different brand or as lower quality, lower priced product. Note that other example processes may be much more complex, involving hundreds of actuators and sensors and various processing elements.

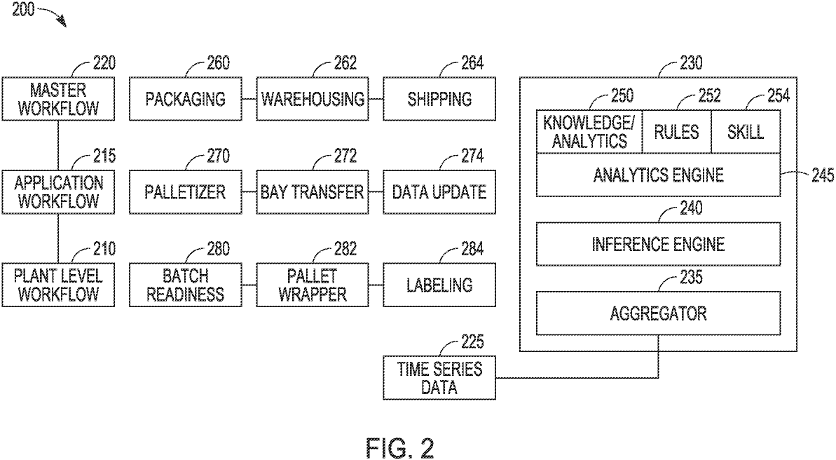

FIG. 2 illustrates a packaging operation product batch workflow generally at 200. Basically, product manufactured, such as by batch process 100. is provided to workflow 200. Data regarding various workflow levels, such as plant level workflow 210, application workflow 215, and Manufacturing Execution System (MES) workflow 220 is collected by suitable sensors and provided as time series data 225 to a system 230. Data may also be collected by operators using handheld devices.

The system 230 includes a data aggregator 235 that receive the sensed data and aggregates the data in manners appropriate to the type of workflow sensed. Note that system 230 may be integrated with controller 125 or may be a separate system that receives the time series data 225. Temperature data may be averaged or otherwise aggregated to determine a rate of change, or even sampled at discrete intervals to produce various kinds of aggregated data. The system includes an inference engine 240 that examines the aggregated data to draw conclusions about the information they contain and to identify anomalies in the aggregated data as compared to data corresponding to a good workflow for the product, referred to as golden batch data. Golden batch data may be the aggregated data for a batch that turned out to have the highest quality.

Following the aggregation and inferencing of the collected data, the analytics engine 245 is used to identify an action to take during the workflow. In one embodiment, the analytics engine includes at least one of three or four main components:

A knowledge component 250 based on theory which enables to drive decision making or generating the solutions based on theoretical concepts of manufacturing or process;

A rules component 252 based on heuristic rules which enables faster decision making or generating solutions based on situations and conditions at different stages and level. An example rule might be based on temperature exceeding a certain level corresponding to an action of discarding the product;

A skill component 254 or module based on an Operator’s tacit knowledge or supervisor’s practical knowledge which generate solutions based on historic transactions and skill dimension; and

An analytics component that may also be included in the knowledge component 250. The Analytics component contains multiple models for the operations. Each model is resulting the solutions based on live data of shop floor or MES data and inference carried out by data inference engine.

Master (MES) workflow 220 is a workflow which is responsible for the overall operations of the particular sections and it is interacting with another section. For example, packaging operations 260 at this workflow level include palletizer, wrapper, and labeler supervisory functions. Warehousing operations 262 include warehouse, load planning, and bay allocation functions. Shipping operations 264 includes load planning and shipping functions.

Application workflow 215 is guided by MES workflow and all operations are carried out in sequence or parallel in the applications. Notifications, suggestion and recommendation are provided based on deviation in the operations steps. Palletizer operations 270 include batch readiness, palletizer and labeler functions. Bay transfer 272 includes move to bay, and update bay inventory functions. Data update 274 includes warehouse and production data as well as order data.

Plant/shop floor workflow 210 is related to material movements in term of quality, time and quantity along with plant. Workflow 210 provides insight at a root level for deviations in the production of product. Batch readiness 280 includes product from batch production and packaging material. Palletizer/wrapper 282 related to volume/level filling, weighing, and wrapping functions. Labeler 284 includes hazardous label, carboard label, and container label functions.

In various embodiments, analytics and decision-based orchestrations integrate the entire level from shop floor to enterprise resource planning (ERP). Identification of issues at the various functions described, and corresponding issue resolution may be based on at least one of, rules, skill and analytics. Data aggregation via aggregator 235 for multiple levels is provided to derive the proper decision making. The data inference engine 240 has a unique way to identify the deviation at multiple stages. The inference engine 240 infers problems by finding batches having similar conditions using naive probability, finding best suitable routes to resolve the issue-based neutralizing the deviation with help of branch and bound algorithms whenever applicable, and via based routes, solutions are generated from skill 254, knowledge 250, rules 252 and analytics 252. Analytics 252 contains multiple models for the operations. Each model derives solutions based on live data of shop floor or MES data and inference carried out by the inference engine 240.

New solutions along with all options or combination of all available options may also be found. Impacted parameters are identified by design of experiment systems validated with hypothesis systems. Based on hypothesis, solutions may be generated.

In one embodiment, the analytics engine 245 contains four parts including one or more knowledge 250 components, rules 252 components, skill 254 components, and analytics 250 components which generate the solutions, including workarounds, alternatives, or rework workflow for the operations.

The solutions may modify workflow by taking actions or perform correct actions at the right time by the right users which can enhance both quality and productivity.

The analytics engine 245 identifies a solution from likely solutions based on impacts of each of the solutions generated by the various components. Descriptive, predictive, and perspective analytics are based on plant dynamic data. Supervised learning for the analytics engine may be used to learn efficient solutions over a period of time. Solution quality will improve over period-based user ratings for the solutions.

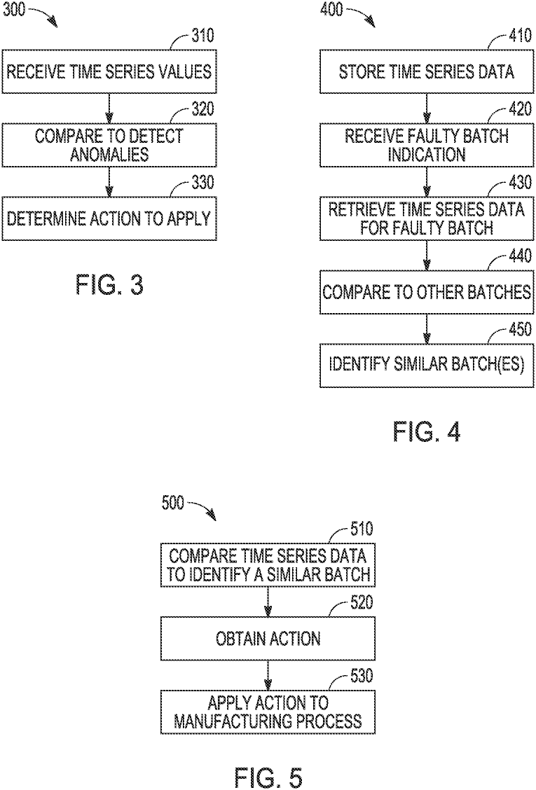

FIG. 3 is a flowchart illustrating a computer implemented method 300 for recommending actions in response to a manufacturing processing deviating from an ideal set of measured parameters. Method 300 begins at operation 310 by receiving time series values of one or more sensed parameters of a product manufacturing process. The sensed parameters may include pressure, temperature, flow rate, and other manufacturing related parameters. In one embodiment, the manufacturing process may be a batch process where a batch of material is processed to result in one or more products or end materials. The process may also be continuous is some embodiments as even continuous processes may have portions that can be similarly monitored to produce time series values representative of the state of the manufacturing process at various points in time. Products range from food products such as yogurt, mechanical parts, such as aircraft parts, or even oil processing to name a few.

The received time series values are compared at operation 320 to desired time series values to detect one or more anomalies in the received time series values. In various embodiments the time series data is aggregated and has associated time stamps that are relative to a start of a process, or absolute and compared to the time at the start of the process to determine the time relative to the start.

While exact parameter values are compared in one embodiment, aggregated values may also be compared. The aggregated values may include statistical data, such as averages over various times, rates of change, and other meaningful statistical aggregations. Aggregating the values includes gathering the time series data for each sensed parameter in a cohesive manner and providing a context for the time series data. Contexts include the type of process being used and particular settings, such as winter/spring/other type settings. The desired time series values are ideal or golden batch values in various embodiments, with the anomalies being detected based on a threshold difference from the ideal values. The desired time series values are updated in one embodiment to reflect batches of product that were of even higher quality than a previous golden batch.

At operation 330, an action to apply to the product manufacturing process based on the one or more detected anomalies is determined. The action may be determined using the analytics engine using one or more of knowledge, rules, and skills. Action may include one or more of modifying parameters of actuators to change temperatures, flow rates, or other parameters of the manufacturing process, accept the batch, send the batch for analysis, process the remaining process product further, recycle the batch, dispose, etc. In one embodiment, operation 330 determines an action by a machine learning model trained on historic labeled time series values of prior product manufacturing processes. The labels correspond to actions taken.

The aggregated time series data includes a time stamp with each value and includes an associated product manufacturing process context. Comparing the received time series values to desired time series values includes comparing the aggregated received time series values to aggregated desired time series values. For example, one or more of temperature of a material at a point in time, or average temperature over different time periods, or total aggregated temperature, or first derivative of temperature deviations from corresponding golden batch temperatures are compared. Note that there may be multiple process temperatures, pressures, flow rates, or other parameter values that may be compared, at the same point.

FIG. 4 is a flowchart illustrating a computer implemented method 400 of tracking produced products and corresponding time series data recorded during product manufacturing. At operation 410, the time series data for each batch of product manufactured may be stored, such as in a database. Each product or batch may have an ID to associate the product or batch with the stored time series data. An indication of a first faulty batch of product previously manufactured is received at operation 420. The time series data for the first faulty batch is retrieved at operation 430 from the stored time series data. At operation 440, the time series data from the first faulty batch is compared to the time series data for the other batches of product manufactured that has been stored. At operation 450, other batches having similar time series data are identified.

FIG. 5 is a flowchart illustrating a computer implemented method 500 of an alternative way of determining an action 330 to be performed with respect to manufacture of a product that has deviated from ideal parameters values. At operation 510 the time series data is compared to sets of time series data of prior product manufacturing processes, each having an associated action and identifying one of the sets of time series data of prior product manufacturing process. The comparison may be performed by using the analytics engine to identify matches with a desired confidence level, such as 90%, or other desired confidence level. The confidence level may be adjusted based on testing of identified products. If all batches at 90% confidence are found to have faulty products, the confidence level may be reduced to identify more batches. In further embodiments, a statistical analysis may be used to identify similar batches. In one example, one or more of the parameter values deviating furthest from the ideal values may be used to identify similar batches by comparing such values and selecting other batches within a desired threshold difference. A threshold value or percentage may be used and modified as above based on testing.

At operation 520, the associated action of the identified one of the sets is obtained. At operation 530, the associated action is applied to the manufacturing process. In further embodiments, determining an action may be based on operator skill, process control rules, or analysis of manufacturing plant data.

In further embodiments, the analytics engine may be used outside of manufacturing settings. One example includes evacuating a building or area based on an emergency, such as flooding or fires. The number of people sensed in a building, control of exits that are open, and routes that are available may correspond closely with process control used during manufacturing products. Patterns in measured data may be used to control the number of exits and even direct people to a better exit to better control the evacuation process and dynamically react to detected anomalies during the evacuation by identifying actions and proceeding to execute such identified actions.

In some embodiments, the analytics engine 245 may utilize artificial intelligence. Artificial intelligence (AI) is a field concerned with developing decision-making systems to perform cognitive tasks that have traditionally required a living actor, such as a person. Artificial neural networks (ANNs) are computational structures that are loosely modeled on biological neurons. Generally, ANNs encode information (e.g., data or decision making) via weighted connections (e.g., synapses) between nodes (e.g., neurons). Modern ANNs are foundational to many AI applications, such as automated perception (e.g., computer vision, speech recognition, contextual awareness, etc.), automated cognition (e.g., decision-making, logistics, routing, supply chain optimization, etc.), automated control (e.g., autonomous cars, drones, robots, etc.), among others.

Many ANNs are represented as matrices of weights that correspond to the modeled connections. ANNs operate by accepting data into a set of input neurons that often have many outgoing connections to other neurons. At each traversal between neurons, the corresponding weight modifies the input and is tested against a threshold at the destination neuron. If the weighted value exceeds the threshold, the value is again weighted, or transformed through a nonlinear function, and transmitted to another neuron further down the ANN graph—if the threshold is not exceeded then, generally, the value is not transmitted to a down-graph neuron and the synaptic connection remains inactive. The process of weighting and testing continues until an output neuron is reached; the pattern and values of the output neurons constituting the result of the ANN processing.

The correct operation of most ANNs relies on correct weights. However, ANN designers do not generally know which weights will work for a given application. Instead, a training process is used to arrive at appropriate weights. ANN designers typically choose a number of neuron layers or specific connections between layers including circular connection, but the ANN designer does not generally know which weights will work for a given application. Instead, a training process generally proceeds by selecting initial weights, which may be randomly selected. Training data is fed into the ANN and results are compared to an objective function that provides an indication of error. The error indication is a measure of how wrong the ANN’s result was compared to an expected result. This error is then used to correct the weights. Over many iterations, the weights will collectively converge to encode the operational data into the ANN. This process may be called an optimization of the objective function (e.g., a cost or loss function), whereby the cost or loss is minimized.

A gradient descent technique is often used to perform the objective function optimization. A gradient (e.g., partial derivative) is computed with respect to layer parameters (e.g., aspects of the weight) to provide a direction, and possibly a degree, of correction, but does not result in a single correction to set the weight to a “correct” value. That is, via several iterations, the weight will move towards the “correct,” or operationally useful, value. In some implementations, the amount, or step size, of movement is fixed (e.g., the same from iteration to iteration). Small step sizes tend to take a long time to converge, whereas large step sizes may oscillate around the correct value, or exhibit other undesirable behavior. Variable step sizes may be attempted to provide faster convergence without the downsides of large step sizes.

Backpropagation is a technique whereby training data is fed forward through the ANN-here “forward” means that the data starts at the input neurons and follows the directed graph of neuron connections until the output neurons are reached-and the objective function is applied backwards through the ANN to correct the synapse weights. At each step in the backpropagation process, the result of the previous step is used to correct a weight. Thus, the result of the output neuron correction is applied to a neuron that connects to the output neuron, and so forth until the input neurons are reached. Backpropagation has become a popular technique to train a variety of ANNs.

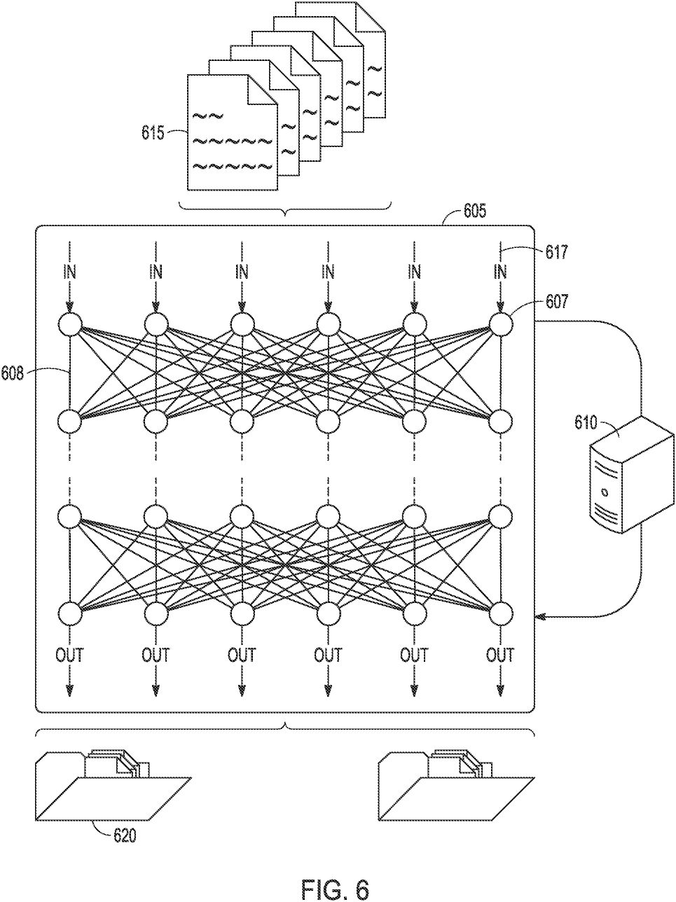

FIG. 6 is a block diagram of an example of an environment including a system for neural network training, according to an embodiment. The system includes an ANN 605 that is trained using a processing node 610. The processing node 610 may be a CPU, GPU. field programmable gate array (FPGA), digital signal processor (DSP), application specific integrated circuit (ASIC), or other processing circuitry. In an example, multiple processing nodes may be employed to train different layers of the ANN 605, or even different nodes 607 within layers. Thus, a set of processing nodes 610 is arranged to perform the training of the ANN 605.

FIG. 6 (Change ref number to start with 6)

The set of processing nodes 610 is arranged to receive a training set 615 for the ANN 605. The ANN 605 comprises a set of nodes 607 arranged in layers (illustrated as rows of nodes 607) and a set of inter-node weights 608 (e.g., parameters) between nodes in the set of nodes. In an example, the training set 615 is a subset of a complete training set. Here, the subset may enable processing nodes with limited storage resources to participate in training the ANN 605.

The training data may include multiple numerical values representative of a domain, such as red, green, and blue pixel values and intensity values for an image or pitch and volume values at discrete times for speech recognition, or in the case of the analytics engine, parameter values and labels. Labels may be actions that were taken. Note that separate models may be trained for different contexts. Each value of the training, or input 617 to be classified once ANN 605 is trained, is provided to a corresponding node 607 in the first layer or input layer of ANN 605. The values propagate through the layers and are changed by the objective function.

As noted above, the set of processing nodes is arranged to train the neural network to create a trained neural network model. Once trained, data input into the ANN will produce valid classifications 620 (e.g., the input data 617 will be assigned into categories), for example. The training performed by the set of processing nodes 607 is iterative. In an example, each iteration of the training the neural network is performed independently between layers of the ANN 605. Thus, two distinct layers may be processed in parallel by different members of the set of processing nodes. In an example, different layers of the ANN 605 are trained on different hardware. The members of different members of the set of processing nodes may be located in different packages, housings, computers, cloud-based resources, etc. In an example, each iteration of the training is performed independently between nodes in the set of nodes. This example is an additional parallelization whereby individual nodes 607 (e.g., neurons) are trained independently. In an example, the nodes are trained on different hardware.

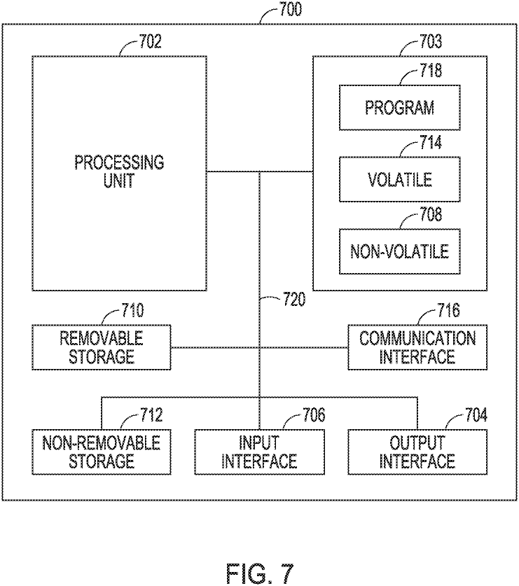

FIG. 7 is a block schematic diagram of a computer system 700 to implement dynamic workflow control and analytics, and for performing methods and algorithms according to example embodiments. All components need not be used in various embodiments.

One example computing device in the form of a computer 700 may include a processing unit 702, memory 703, removable storage 710, and non-removable storage 712. Although the example computing device is illustrated and described as computer 700, the computing device may be in different forms in different embodiments. For example, the computing device may instead be a smartphone, a tablet, smartwatch, smart storage device (SSD), or other computing device including the same or similar elements as illustrated and described with regard to FIG. 7. Devices, such as smartphones, tablets, and smartwatches, are generally collectively referred to as mobile devices or user equipment.

Although the various data storage elements are illustrated as part of the computer 700, the storage may also or alternatively include cloud-based storage accessible via a network, such as the Internet or server-based storage. Note also that an SSD may include a processor on which the parser may be run, allowing transfer of parsed, filtered data through I/O channels between the SSD and main memory.

Memory 703 may include volatile memory 714 and non-volatile memory 708. Computer 700 may include – or have access to a computing environment that includes – a variety of computer-readable media, such as volatile memory 714 and non-volatile memory 708, removable storage 710 and non-removable storage 712. Computer storage includes random access memory (RAM), read only memory (ROM), erasable programmable read-only memory (EPROM) or electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 700 may include or have access to a computing environment that includes input interface 706, output interface 704, and a communication interface 716. Output interface 704 may include a display device, such as a touchscreen, that also may serve as an input device. The input interface 706 may include one or more of a touchscreen, touchpad, mouse, keyboard, camera, one or more device-specific buttons, one or more sensors integrated within or coupled via wired or wireless data connections to the computer 700, and other input devices. The computer may operate in a networked environment using a communication connection to connect to one or more remote computers, such as database servers. The remote computer may include a personal computer (PC), server, router, network PC. a peer device or other common data flow network switch, or the like. The communication connection may include a Local Area Network (LAN), a Wide Area Network (WAN), cellular. Wi-Fi, Bluetooth, or other networks. According to one embodiment, the various components of computer 700 are connected with a system bus 720.

Computer-readable instructions stored on a computer-readable medium are executable by the processing unit 702 of the computer 700, such as a program 718. The program 718 in some embodiments comprises software to implement one or more methods described herein. A hard drive. CD-ROM, and RAM are some examples of articles including a non-transitory computer-readable medium such as a storage device. The terms computer-readable medium and storage device do not include carrier waves to the extent carrier waves are deemed too transitory. Storage can also include networked storage, such as a storage area network (SAN). Computer program 718 along with the workspace manager 722 may be used to cause processing unit 702 to perform one or more methods or algorithms described herein.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be: within the scope of the following claims.

1-20. (canceled)

21. A computer implemented method comprising:
receiving time series data from one or more sensors of a facility, the time-series data associated with a first workflow level and a second workflow level of a plurality of workflow levels of a manufacturing process of the facility;
aggregating the time series data based on a first operation corresponding to the first workflow level and a second operation corresponding to the second workflow level;
detecting one or more anomalies in at least one of the first workflow level and the second workflow level based on a comparison of the aggregated time series data with a set of time series data stored in a database;
correlating the one or more detected anomalies in the at least one of the first workflow level and the second workflow level based at least on one or more historical patterns associated with one or more historical manufacturing processes;
determining at least one action by using a trained machine learning model for the at least one of the first workflow level and the second workflow level, wherein the at least one action comprises modifying one or more parameters of the manufacturing process, and wherein the trained machine learning model is trained based at least on the one or more historical patterns; and
performing the at least one action at the at least one of the first workflow level and the second workflow level to modify the one or more parameters of the manufacturing process.

22. The method of claim 21, wherein receiving the time series data from the one or more sensors of the facility comprises:
receiving one or more measurement values from the one or more sensors in the facility, and wherein the one or more measurement values are related to at least one of: a pressure, a temperature, and a flow rate associated with the manufacturing process.

23. The method of claim 21, wherein aggregating the time series data comprises:
determining statistical values or average values of the time series data based on statistical aggregations; and
providing a context for the aggregated time series data, wherein the context includes at least one of: a type of the manufacturing process and one or more settings of the manufacturing process.

24. The method of claim 21, wherein comparing the aggregated time series data with the set of time series data stored in the database comprises:
identifying at least one set of time series data of the one or more historical manufacturing processes using a confidence level; and
determining a similarity between the at least one set of time series data and the aggregated time series data.

25. The method of claim 21, wherein detecting the one or more anomalies in the at least one of the first workflow level and the second workflow level comprises:
detecting if a deviation between the aggregated time series data and one or more values of the set of time series data exceed a threshold value; and
computing a difference between the aggregated time series data and the one or more values of the set of time series data if the deviation exceeds the threshold value.

26. The method of claim 21, further comprising:
storing the time series data for a plurality of batches of the manufacturing process;
receiving an indication of a first faulty batch of the manufacturing process;
comparing a first set of time series data associated with the first faulty batch with a second set of time series data associated with at least one batch different than the first batch; and
identifying the at least one batch with similar time series data.

27. The method of claim 25, further comprising: updating the set of time series data with the aggregated time series data in response to determining that the deviation does not exceed the threshold value.

28. The method of claim 21, further comprising:
obtaining the trained machine learning model based on a training using the set of time series data stored in the database, wherein at least one set of time series data is labelled with at least one of: a context of the one or more historical manufacturing processes and one or more historical actions.

29. The method of claim 21, wherein determining the at least one action by the trained machine learning model for the at least one of the first workflow level and the second workflow level is based on at least one historical action associated with the set of time series data, wherein the first operation corresponding to the first workflow level and the second operation corresponding to the second workflow level comprises at least one of: packaging operations, warehousing operations, and shipping operations.

30. The method of claim 21, further comprising:
predicting, based on the aggregated time series data, an event at the at least one of the first workflow level and the second workflow level; and
identifying one or more corrective actions based on the predicted event.

31. A machine-readable storage device having instructions for execution by a processor of a machine to cause the processor to perform operations to perform a method, the operations comprising:
receiving time series data from one or more sensors of a facility, the time-series data associated with a first workflow level and a second workflow level of a plurality of workflow levels of a manufacturing process of the facility;
aggregating the time series data based on a first operation corresponding to the first workflow level and a second operation corresponding to the second workflow level;
detecting one or more anomalies in at least one of the first workflow level and the second workflow level based on a comparison of the aggregated time series data with a set of time series data stored in a database;
correlating the one or more detected anomalies in the at least one of the first workflow level and the second workflow level based at least on one or more historical patterns associated with one or more historical manufacturing processes;
determining at least one action by using a trained machine learning model for the at least one of the first workflow level and the second workflow level, wherein the at least one action comprises modifying one or more parameters of the manufacturing process, and wherein the trained machine learning model is trained based at least on the one or more historical patterns; and
performing the at least one action at the at least one of the first workflow level and the second workflow level to modify the one or more parameters of the manufacturing process.

32. The device of claim 31, wherein receiving the time series data from the one or more sensors of the facility comprises:
receiving one or more measurement values from the one or more sensors in the facility, and wherein the one or more measurement values are related to at least one of: a pressure, a temperature, and a flow rate associated with the manufacturing process.

33. The device of claim 31, wherein aggregating the time series data comprises:
determining statistical values or average values of the time series data based on statistical aggregations; and
providing a context for the aggregated time series data, wherein the context includes at least one of: a type of the manufacturing process and one or more settings of the manufacturing process.

34. The device of claim 31, wherein comparing the aggregated time series data with the set of time series data stored in the database comprises:
identifying at least one set of time series data of the one or more historical manufacturing processes using a confidence level; and
determining a similarity between the at least one set of time series data and the aggregated time series data.

35. The device of claim 31, wherein detecting the one or more anomalies in the at least one of the first workflow level and the second workflow level comprises:
detecting if a deviation between the aggregated time series data and one or more values of the set of time series data exceed a threshold value; and
computing a difference between the aggregated time series data and the one or more values of the set of time series data if the deviation exceeds the threshold value.

36. The device of claim 31, wherein the operations further comprise:
storing the time series data for a plurality of batches of the manufacturing process;
receiving an indication of a first faulty batch of the manufacturing process;
comparing a first set of time series data associated with the first faulty batch with a second set of time series data associated with at least one batch different than the first batch; and
identifying the at least one batch with similar time series data.

37. The device of claim 35, wherein the operations further comprises: updating the set of time series data with the aggregated time series data in response to determining that the deviation does not exceed the threshold value.

38. The device of claim 31, wherein the operations further comprise:
obtaining the trained machine learning model based on a training using the set of time series data stored in the database, wherein at least one set of time series data is labelled with at least one of: a context of the one or more historical manufacturing processes and one or more historical actions.

39. The device of claim 31, wherein determining the at least one action by the trained machine learning model for the at least one of the first workflow level and the second workflow level is based on at least one historical action associated with the set of time series data, wherein the first operation corresponding to the first workflow level and the second operation corresponding to the second workflow level comprises at least one of: packaging operations, warehousing operations, and shipping operations.

40. The device of claim 31, wherein the operations further comprise:
predicting, based on the aggregated time series data, an event at the at least one workflow level of the plurality of workflow levels; and
identifying one or more corrective actions based on the predicted event.
